(19) United States
(12) Patent Application Publication
(10) Pub. No.: US 2017/0318624 A1
(43) Pub. Date: Nov. 2, 2017

(54) Extendible Heating Tool

(71) Applicant: GOODHOUSE Enterprise Co. Ltd., Taichung City (TW)

(72) Inventor: Jung-Fa Tsai, Taichung (TW)

(21) Appl. No.: 15/140,545

(22) Filed: Apr. 28, 2016

(51) Int. Cl. H05B 3/02; H05B 3/03; H05B 1/02

(52) U.S. Cl. CPC H05B 3/026; H05B 1/0288; H05B 3/03

(57) ABSTRACT

An extendible heating tool includes a body and an extendible heating head releasably engaged with and electrically connected to the body. The body includes a head tip and a first and second electrode disposed in the head tip. The extendible heating head includes a first conductive member electrically connected to the first electrode and a second conductive member electrically connected to the second electrode respectively. The extendible heating head also includes a first conductive extension member telescopically coupled to the first conductive member and a second conductive extension member telescopically coupled to the second conductive member respectively. The first and second conductive extension members are configured to extend from and retract towards the corresponding first and second conductive members.

### BACKGROUND OF THE INVENTION

### 1. Field of the Invention

The present invention relates to a heating tool and, particularly, to an extendible heating tool with an extendible heating head.

### 2. Description of the Related Art

TW Pat. Pub. No. 201529216 shows an electric heating tool. The electric heating tool includes a body to which a power connecting member is mounted. A heating device includes a power connector, a seat mounted to the power connector, two connection legs, and a heating element. The power connector is mounted to the power connecting member and has two electrodes electrically connected to two electrodes of the power connecting member. Each connection leg is received in one of two through-holes of the seat and includes a connection end and a heating end. The connection ends of the connection legs are electrically connected to the electrodes of the power connector. The heating element is connected to the heating ends of the connection legs.

Because such electric heating tool has a compact size, it can be carried or stored easily, but it becomes useless if an object to be heated is unreachable or difficult to be reached.

The present invention, therefore, is intended to obviate or at least alleviate the problems encountered in the prior art.

### SUMMARY OF THE INVENTION

According to the present invention, a heating tool is extendible and includes an extendible heating head. The extendible heating head is releasably engagable with the heating tool. The extendible heating head includes a connecting seat which has an end including a first receiving structure and a second receiving structure. A first conductive member is connected to the first receiving structure. A second conductive member is connected to the second receiving structure. A first conductive extension member is electrically connected to and telescopically coupled to the first conductive member and is configured to extend from and retract towards the first conductive member, with the first conductive extension member being adapted to slide relative to the first conductive member, and with the first conductive extension member having a first end joined to the first conductive member and a second end defining a free end of the first conductive extension member. A second conductive extension member is electrically connected to and telescopically coupled to the second conductive member and is configured to extend from and retract towards the second conductive member, with the second conductive extension member being adapted to slide relative to the second conductive member, and with the second conductive extension member having a first end joined to the second conductive member and a second end defining a free end of the second conductive extension member. A heating coil is electrically connected to and disposed on the first and second conductive extension members. The heating coil is disposed at a first distance distal to the connecting seat and that the first and second conductive extension members are extended from the corresponding first and second conductive members. The heating coil is disposed at a second distance, which is smaller than the first distance, distal to the connecting seat and that the first and second conductive extension members are retracted towards the corresponding first and second conductive members. The first and second conductive extension members are adapted to extend and retract concurrently.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide an extendible heating tool.

It is another objective of the present invention to provide an extendible heating tool that can be carried and stored easily as well as have an improved operation range.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of an extendible heating tool in accordance with the present invention.

FIG. 2 is an exploded perspective view of the extendible heating tool of the present invention.

FIG. 3 is a cross-sectional view of the extendible heating tool of the present invention.

FIG. 4 is a partial, enlarged, cross-sectional view of FIG. 4.

FIG. 5 is a partial, cross-sectional view showing the extendible heating tool of the present invention in an extended position.

FIG. 6 is a partial, cross-sectional view showing a sheath of the extendible heating tool of the present in an open position.

### DETAILED DESCRIPTION OF THE INVENTION

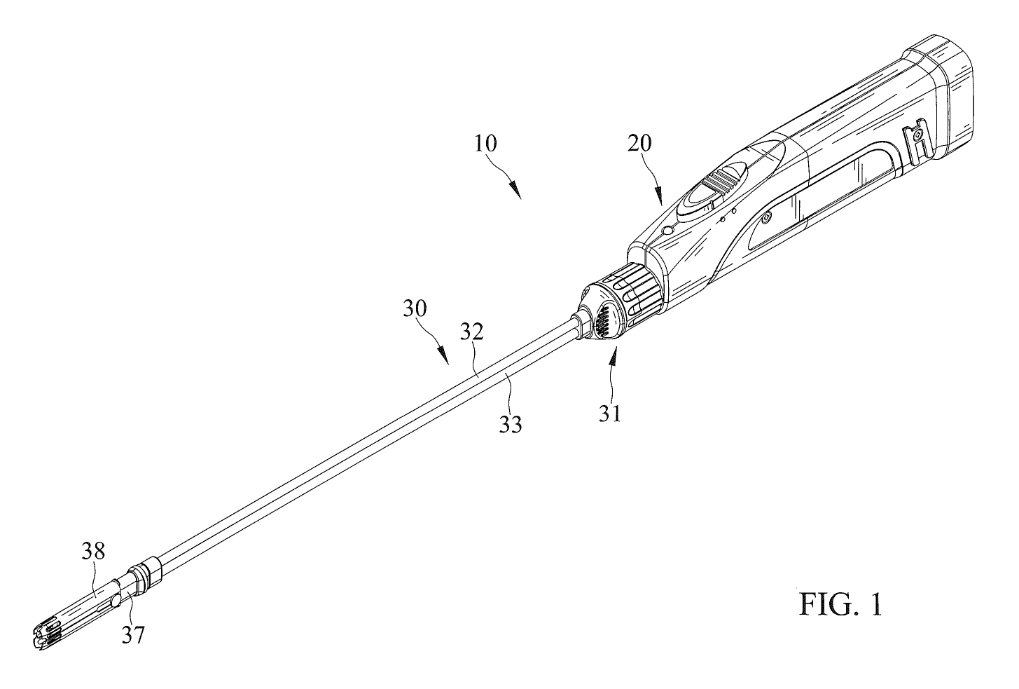

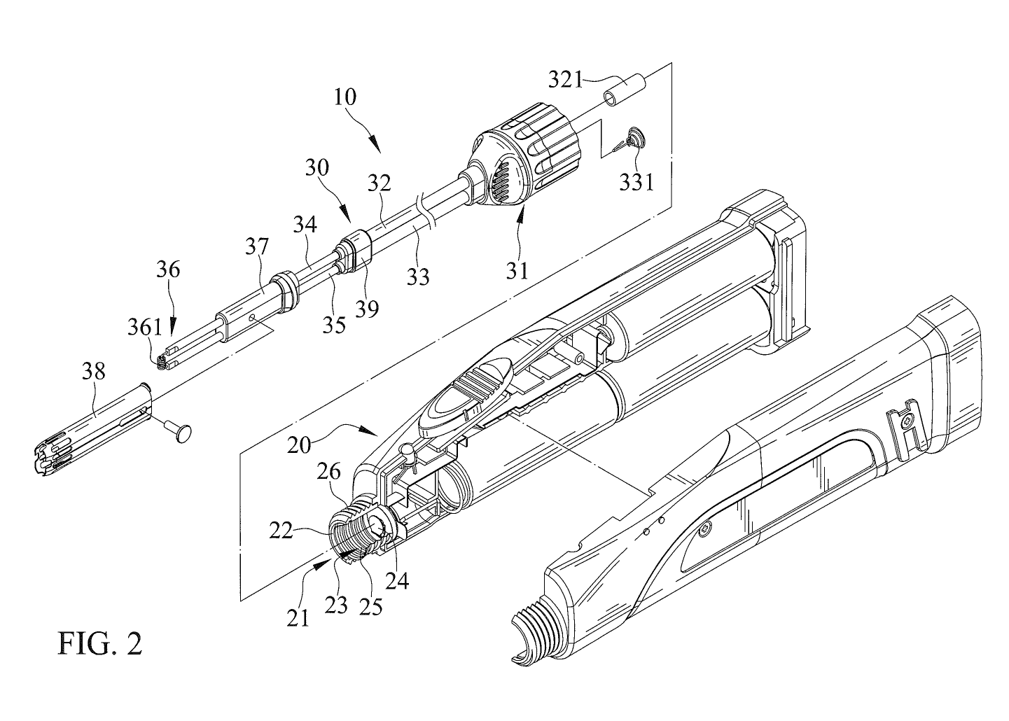

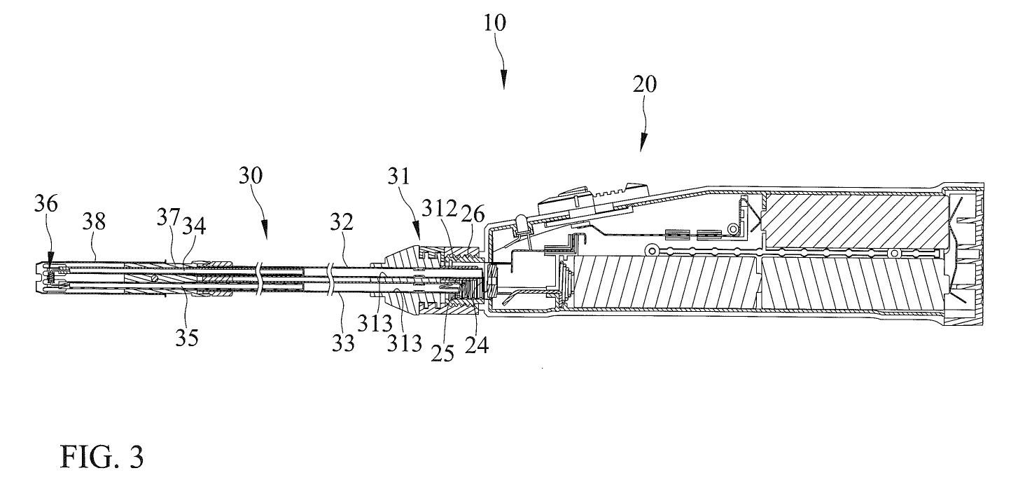

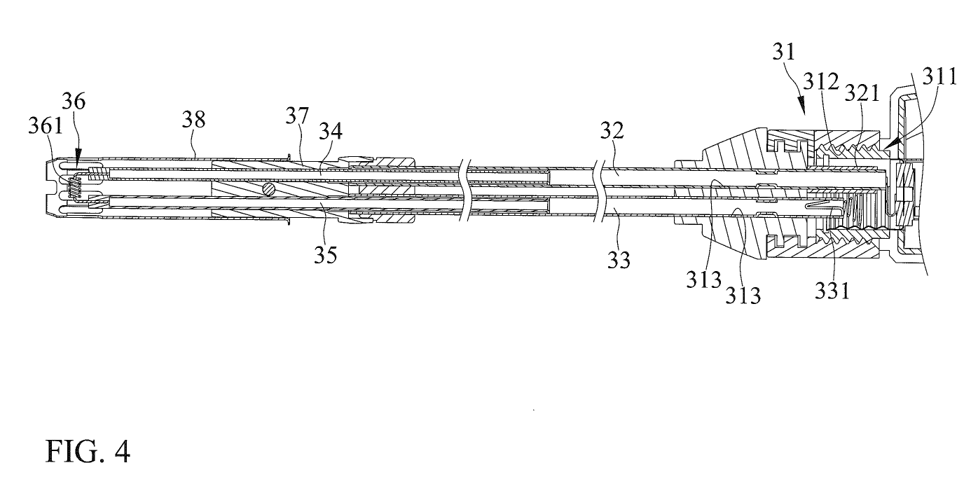

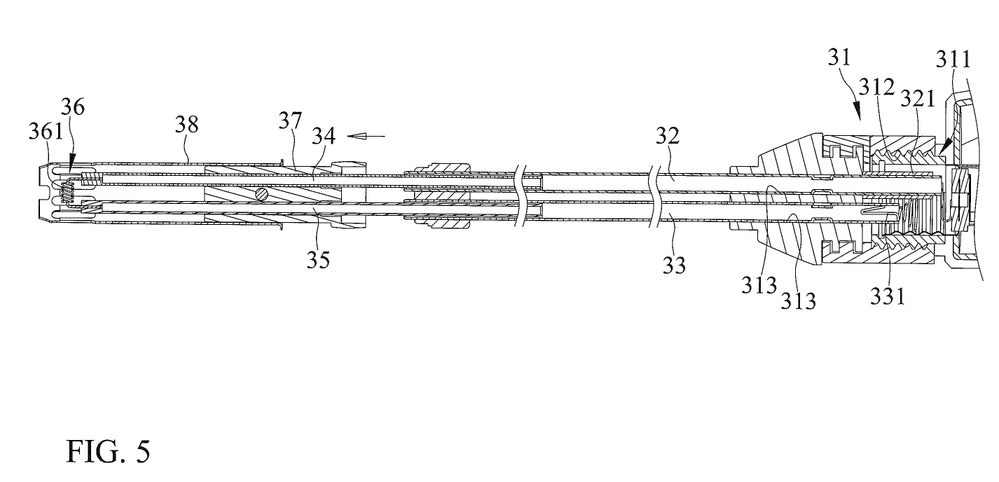

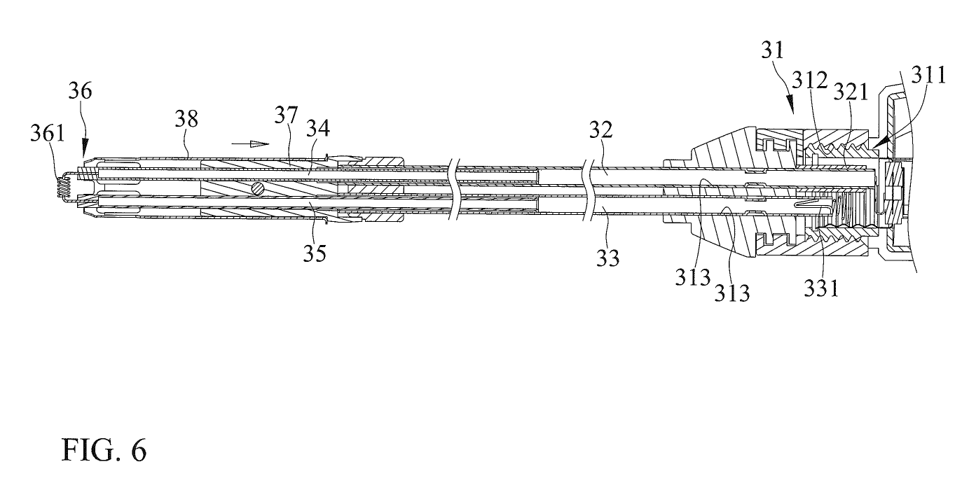

FIGS. 1 through 6 show an extendible heating tool 10. The extendible heating tool 10 includes a body 20 and an extendible heating head 30 releasably engaged with and electrically connected to the body 20. The body 20 defines a grip on which allows a user of the extendible heating tool to grasp. The body 20 also defines a room for receiving at least one battery which powers the extendible heating tool 10. The body 20 includes a head tip 21 which includes an annular wall 22 and defines a cavity 23 in the annular wall 22. The head tip 21 includes a first and second electrode 24 and 25 disposed in the cavity 23. One of the first and second electrodes 24 and 25 is positive while the other is negative.

The extendible heating head 30 includes a connecting seat 31 having an end including a first receiving structure and a second receiving structure. The connecting seat 31 is made of insulating material. The connecting seat 31 is releasably engaged with the head tip 21 of the body 20. The annular wall 22 includes first threads 26 and the periphery of the connecting seat 31 includes second threads 312 in thread engagement with the first threads 26. The connecting seat 31 defines a compartment 311 and the first and second receiving structures each define a through hole 313 and are connected to the compartment 311. Each of the first and second conductive members 32 and 33 has an end inserted in the compartment 311. The compartment 311 includes an insulating sleeve 321 disposed therein. Further, a first conductive member 32 is connected to the first receiving structure. The first conductive member 32 allows electricity to pass it. The first conductive member 32 is inserted in the insulating sleeve 321. Further, a second conductive member 33 is connected to the second receiving structure. The second conductive member 33 allows electricity to pass it. The second conductive member 33 includes a connector 331 electrically connected thereto. The connector 331 has a first end abutting the second conductive member 33 and a second end abutting the second electrode 25. The connector 331 has a coiled shape. The second conductive member 33 is hollow and defines a space in which the first end of the connector 331 is inserted. The first and second conductive members 32 and 33 each have an end inserted into the through holes 313 of the corresponding first and second receiving structures. Further, a first conductive extension member 34 is telescopically coupled to the first conductive member 32 and is configured to extend from and retract towards the first conductive member 32. The first conductive extension member 34 allows electricity to pass it. The first conductive member 32 and the first conductive extension member 34 are electrically conductive and are electrically connected together. The first conductive extension member 34 is adapted to slide relative to the first conductive member 32. The first conductive extension member 34 has a first end joined to the first conductive member 32 and a second end defining a free end of the first conductive extension member 34. Further, a second conductive extension member 35 is telescopically coupled to the second conductive member 33 and is configured to extend from and retract towards the second conductive member 33. The second conductive extension member 35 allows electricity to pass it. The second conductive member 33 and the second conductive extension member 35 are electrically conductive and are electrically connected together. The second conductive extension member 35 is adapted to slide relative to the second conductive member 33. The second conductive extension member 35 has a first end joined to the second conductive member 33 and a second end defining a free end of the second conductive extension member 35. Further, a heating coil 36 is electrically connected to and disposed on the first and second conductive extension members 34 and 35. The heating coil 36 is electrically conductive and has a first end electrically connected to the first conductive extension member 34 and a second end electrically connected to the second conductive extension member 35 respectively. Thus, the first and second conductive members 32 and 33 and the first and second conductive extension members 34 and 35 and the heating coil 36 each allow electricity to pass them and form an electric circuit. Furthermore, the heating coil 36 generates heat when operating the extendible heating tool 10. The heating coil 36 has a first end connected to the first conductive extension member 34 and a second end connected to the second conductive extension member 35, respectively. A portion 361 of the heating coil 36 that generates heat is between the first and second ends of the heating coil 36. The portion 361 is spiraled.

The extendible heating tool 10 is movable between an extended position and a retracted position. The first and second conductive extension members 34 and 35 are extended from the corresponding first and second conductive members 32 and 33 when the extendible heating tool 10 is disposed in the extended position. The first and second conductive extension members 34 and 35 are retracted towards the corresponding first and second conductive members 32 and 33 when the extendible heating tool 10 is disposed in the retracted position. The heating coil 36 is disposed at a first distance distal to the connecting seat 31 and that the first and second conductive extension members 34 and 35 are extended from the corresponding first and second conductive members 32 and 33. The heating coil 36 is disposed at a second distance, which is smaller than the first distance, distal to the connecting seat 31 and that the first and second conductive extension members 34 and 35 are retracted towards the corresponding first and second conductive members 32 and 33. Furthermore, the first and second conductive extension members (34, 35) are adapted to extend and retract concurrently.

In addition, a joint 37 is coupled to the first and second conductive extension members 34 and 35. The joint 37 includes two holes extending therethrough and receiving the first and second conductive extension members 34 and 35. Thus, the first conductive extension member 34 inserts through one of the holes and the second conductive extension member 35 inserts through the other hole. The joint 37 includes a sheath 38, which is hollow and defines a space into which the first and second conductive extension members 34 and 35 are inserted, mounted on the joint 37. The sheath 38 is movable to a closed position in which the heating coil 36 is disposed outside the sheath 38 and an open position in which the heating coil 36 is disposed within the sheath 38. Further, a lock 39 is fixedly mounted on the first and second conductive extension members 34 and 35. The joint 37 is releasably engaged with the lock 39. The joint 37 engages with and is restrained at a fixed position by the lock 39 when the sheath 38 is in the closed position. The joint 37 disengages from the lock when the sheath 38 is in the open position.

In view of the forgoing, the extendible heating tool 10 can be carried and stored easily as well as have an improved operation range because the first and second conductive extension member 34 and 35 are configured to extend from and retract towards the corresponding first and second conductive member 32 and 33.

The foregoing is merely illustrative of the principles of this invention and various modifications can be made by those skilled in the art without departing from the scope and spirit of the invention.

What is claimed is:

1. An extendible heating head for a heating tool is releasably engagable with the heating tool, comprising:
a connecting seat having an end including a first receiving structure and a second receiving structure;
a first conductive member connected to the first receiving structure;
a second conductive member connected to the second receiving structure;
a first conductive extension member electrically connected to and telescopically coupled to the first conductive member and configured to extend from and retract towards the first conductive member, with the first conductive extension member being adapted to slide relative to the first conductive member, and with the first conductive extension member having a first end joined to the first conductive member and a second end defining a free end of the first conductive extension member;
a second conductive extension member electrically connected to and telescopically coupled to the second conductive member and configured to extend from and retract towards the second conductive member, with the second conductive extension member being adapted to slide relative to the second conductive member, and with the second conductive extension member having a first end joined to the second conductive member and a second end defining a free end of the second conductive extension member; and
a heating coil electrically connected to and disposed on the first and second conductive extension members, wherein the heating coil is disposed at a first distance distal to the connecting seat and that the first and second conductive extension members are extended from the corresponding first and second conductive members, and wherein the heating coil is disposed at a second distance, which is smaller than the first distance, distal to the connecting seat and that the first and second conductive extension members are retracted towards the corresponding first and second conductive members;
wherein the first and second conductive extension members are adapted to extend and retract concurrently.

2. The extendible heating head as claimed in claim 1, wherein the connecting seat is made of insulating material, wherein the first conductive member, the first conductive extension member, the second conductive member, the second conductive extension member and the heating coil are electrically conductive and cooperate to form an electric circuit.

3. The extendible heating head as claimed in claim 1 further comprising a joint coupled to the first and second conductive extension members, wherein the joint includes a sheath, which is hollow and defines a space into which the first and second conductive extension members are inserted, mounted on the joint, and wherein the sheath is movable to a closed position in which the heating coil is disposed outside the sheath and an open position in which the heating coil is disposed within the sheath.

4. The extendible heating head as claimed in claim 3, wherein the joint includes two holes extending therethrough and receiving the first and second conductive extension members.

5. The extendible heating head as claimed in claim 3 further comprising a lock fixedly mounted on the first and second conductive extension members, wherein the joint is releasably engaged with the lock, wherein the joint engages with and is restrained at a fixed position by the lock when the sheath is in the closed position, and wherein the joint disengages from the lock when the sheath is in the open position.

6. The extendible heating head as claimed in claim 1, wherein the connecting seat defines a compartment and the first and second receiving structures each define a through hole and are connected to the compartment, wherein each of the first and second conductive members has an end inserted in the compartment, wherein the compartment includes an insulating sleeve disposed therein, wherein the first conductive member is inserted in the insulating sleeve.

7. An extendible heating tool comprising:
a body including a head tip which includes an annular wall and defines a cavity in the annular wall and includes a first and second electrode disposed in the cavity;
an extendible heating head releasably engaged with and electrically connected to the body, with the extendible heating head including a connecting seat, with the connecting seat releasably coupled to the head tip of the body, with the extendible heating head including a first and second conductive member and a first and second conductive extension member and a heating coil, with the first and second conductive members connected to the connecting seat, with the first conductive member electrically connected to the first electrode and the second conductive member electrically connected to the second electrode respectively, with the first conductive extension members telescopically coupled to the first conductive members and the second conductive extension members telescopically coupled to the second conductive members respectively, with the first and second conductive extension member configured to extend from and retract towards the corresponding first and second conductive member, with the heating coil electrically connected to and disposed on the first and second conductive extension members.

8. The extendible heating head as claimed in claim 7 wherein the second conductive member includes a connector electrically connected thereto, and wherein the connector has a first end abutting the second conductive member and a second end abutting the second electrode.

9. The extendible heating head as claimed in claim 7, wherein the connecting seat includes a periphery engaging with the annular wall of the head tip of the body, and wherein the annular wall includes first threads and the periphery of the connecting seat includes second threads in thread engagement with the first threads.

10. The extendible heating head as claimed in claim 7 further comprising a joint coupled to the first and second conductive extension members, wherein the joint includes a sheath, which is hollow and defines a space into which the first and second conductive extension members are inserted, mounted on the joint, and wherein the sheath is movable to a closed position in which the heating coil is disposed outside the sheath and an open position in which the heating coil is disposed within the sheath.

11. The extendible heating head as claimed in claim 10, wherein the joint includes two holes extending therethrough and receiving the first and second conductive extension members.

12. The extendible heating head as claimed in claim 10 further comprising a lock fixedly mounted on the first and second conductive extension members, wherein the joint is releasably engaged with the lock, wherein the joint engages with and is restrained at a fixed position by the lock when the sheath is in the closed position, and wherein the joint disengages from the lock when the sheath is in the open position.
